(19) United States
(12) Patent Application Publication
(10) Pub. No.: US 2003/0061095 A1
(43) Pub. Date: Mar. 27, 2003

(54) Content delivery system and server, and computer-readable recording medium in which a content delivery management program is recorded

(75) Inventors: Toru Kamada, Kawasaki (JP); Yasuyuki Nakata, Kawasaki (JP); Koichi Oikawa, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/095,031

(22) Filed: Mar. 12, 2002

(30) Foreign Application Priority Data
Sep. 26, 2001 (JP) 2001-294417

(51) Int. Cl. G06F 17/60

(52) U.S. Cl. 705/14; 725/32

(57) ABSTRACT

A system for automating a process of organizing programming in which more popular Internet content is associated with an advertisement with a higher advertisement rate in a dynamic way. Such programming will enable viewers to listen to and watch contents and advertisements in a non-selective manner as in the case of telecasting. The system includes means for registering each content to be delivered to the user; means for registering each advertisement to be delivered to the user; means for organizing the programming in which the registered contents and advertisements are associated with one another according to the number of accesses to the content and the amount of payment for the advertisement; means for sending out programming information about the organized programming; and a player for reproducing the programming according to the programming information, so that the contents and the advertisements both forming the programming are offered to the user.

### BACKGROUND OF THE INVENTION

1. Field of the Invention

The present invention relates to a content delivery system and server for delivering programming, which is formed of content and advertisement, across a communications network to a player on the user side. The invention also relates to a computer-readable recording medium in which a content delivery management program is recorded. In particular, the invention relates to a technique for organizing a programming list in which information units are listed whose essential element is a uniform resource locator (URL) of Internet content, and to a technique for delivering such a programming list to a player (hereinafter also called “home page player”) which successively shows/reproduces the content according to the programming list.

2. Description of the Related Art

TV broadcasters offer a wide variety of programming as a datastream that is received and viewed non-selectively by viewers. The programming is a combination of advertisements and contents collected and/or produced by the broadcasters.

With recent Internet connection services which allow users to continuously access the Internet all the time, and with recent broadband network services, it is possible for users to always enjoy ads and content on the Internet. Differing from TV broadcasting, ads and content are often provided on the Internet by private individuals or companies, from servers storing such ads and content.

The following is a common method for users to refer to Internet ads and content distributed among many servers on the Internet. For example, URLs of ads and content are written in a hypertext markup language (HTML) file, and hyperlinks are placed to the URL. The HTML file is then delivered to users' browsers. Upon receipt of the HTML file, a user opens the file and selectively activates the hyperlinks to refer to and view the ads and content the user whishes to.

At that time, a conventional player for reproducing downloaded files and streaming files of music/movie content, executes files that record content URLs and reproduction parameters (layout and reproduction timing) in a dedicated language which is capable of describing reproduction sequence of the content, thereby reproducing the ads and content. The user then refers to/listens to and watches the ads and content thus reproduced on the player.

In such an HTML-file-based content delivery system, however, a user must designate and activate a hyperlink through a browser to refer to content, so that the content cannot be offered to the user through the browser as a non-selective datastream in the similar way to TV broadcasting. As mentioned above, as users have recently been allowed to access the Internet continuously all the time, and as broadband networks have recently been realized, a system is desired which provides users with Internet ads and content distributed among many servers on the Internet as a non-selective datastream in the similar way to TV broadcasting.

A reproduction sequence to be reproduced on a conventional player is described in a dedicated language in such a way that a layout of two or more part components and their reproduction timing are involved in one content. A single sequence to be created and offered thus takes the form of a closed file, or an unchangeable file. Accordingly, it has been difficult to update part contents or the sequence in a dynamic way, and it has also been difficult to create programming in which ads and content are associated with one another in a dynamic way.

In the meantime, under present circumstances, it is difficult for content providers to find advertisers who provide ads to be incorporated with the content. On the other hand, it is difficult for advertisers to find popular content to which they want to provide their ads. In addition, practical steps for inserting ads into content have been troublesome. Hence, a system is longed which automates a process for organizing programming in which a more popular content is associated with an ad for which a greater amount of payment is expected to be made. In the system, content providers and advertisers have only to register the contents and advertisements to deliver such contents and advertisements as programming to users' home page players.

### SUMMARY OF THE INVENTION

With the foregoing problems in view, one object of the present invention is to provide a system for automating a process of organizing programming in which more popular content is associated with an advertisement with a higher advertisement rate in a dynamic way. Such programming will enable viewers to listen and watch contents and advertisements in a non-selective manner like TV programming.

Another object of the invention is to provide a server for use in the above-mentioned system.

A further object of the invention is to provide a computer-readable recording medium storing a content delivery management program.

In order to accomplish the above object, according to the present invention, there is provided a content delivery system for delivering programming across a communications network to a user, the system comprising: content registering means for registering each content to be delivered to the user; advertisement registering means for registering each advertisement to be delivered to the user; means for organizing the programming, which is formed of such contents, which have been registered by the content registering means, and such advertisements, which have been registered by the advertisement registering means, in combination created dynamically based upon both the number of accesses to the content and the amount of payment for the advertisement; means for sending out programming information about the programming, which has been organized by the programming organizing means, to the user; and a player for reproducing the programming according to the programming information, so that the contents and the advertisements both forming the programming are offered to the user.

As one generic feature of the present invention, there is provided a content delivery server, communicably connected with a player on a user side across a communications network, for delivering programming to the player. The server comprises: the above-mentioned content registering means; advertisement registering means; programming organizing means; and programming information sending-out means. As one preferred feature, the content registering means registers each content in the form of first address information (hereinafter called “content address information”) about an address of the content on the content server; the advertisement registering means registers each advertisement in the form of second address information (hereinafter called “advertisement address information”) about an address of the advertisement on the advertisement server; the programming organizing means organizes the programming in the form of a made-for-delivery programming list in which both the content address information and the advertisement address information are listed; and the programming information delivery means sends out the made-for-delivery programming list as the programming information.

As another generic feature, there is provided a recording medium in which a content delivery management program for a computer to manage the delivering of programming, sent out on a communications network and directed to a player on a user side, is recorded. The program instructs the computer to function as the above-mentioned: content registering means; advertisement registering means; programming organizing means; and programming information sending-out means.

The present invention guarantees the following advantageous results.

(1) A programming organizing means dynamically combines content items, which have been registered by content registering means, and advertisements, which have been registered by an advertisement registering means, according to the number of accesses to each content item and the advertisement rate, thereby organizing programming. A programming information delivery means sends out programming information of the thus organized programming to a user, and a player on the user side reproduces the received programming. As a result, it is possible to provide an automatic way for organizing programming in which content with higher popularity is dynamically combined with an advertisement with a greater advertisement rate. Further, it is possible for a content provider and an advertiser to deliver their content and advertisement as such programming to a player of a user, merely by registering the URLs of the content and advertisement to be delivered through the content registering means and the advertisement registering means, respectively. Upon receipt of the thus organized programming, a user can reproduce the content and advertisements on the player in a non-selective manner like a datastream offered in telecasting.

(2) The URLs (address information) of the content and advertisements are registered, instead of the content and advertisement themselves. The registered URLs are organized into a programming list, and the programming list is then delivered to a player. Upon receipt of the programming list, the player reads out the content and advertisements corresponding to the URLs recorded in the programming list to reproduce them. As a result, once content providers and advertisers accumulate and store their content and advertisements they would like to provide to users in a content server and an advertisement server, respectively, on the Internet, it is possible for them to register with significant ease the URLs of such content and advertisements in a content delivery server (content delivery site). Further, programming organizing means is capable of organizing programming with significant ease by utilizing the URLs of the content and advertisements. Further, even if such content and advertisements are stored in a number of servers on the Internet, the content delivery system (content delivery server) plays a leading role in organizing content and advertisements into programming as in the case of telecasting. That is, it is possible for Internet viewers (users) to enjoy such programming that is formed of varying content items, including those provided by private individuals and also those provided by business companies, stored in distributed servers on the Internet. The content items forming the programming are reproduced in a non-selective manner like a datastream of telecasting.

(3) A counter means counts the number of accesses to each of the registered contents. The programming is updated at regular intervals according to the access counts, so that the access counts, which indicate the popularity of the contents, can be dynamically reflected on the programming. Accordingly, even with changes in the number of accesses to each content, it is always possible to recognize an content item which is frequently accessed, or high-rated content, and it is possible to associate such popular content with advertisement for which a high advertisement rate is expected to be paid. At that time, the player notifies counter means that access was made to a content file, and upon receipt of the access notification, counter means increments the access count of the corresponding content, so that the number of accesses to each content can be counted with ease and certainty.

(4) When registering an advertisement URL, an advertiser declares how much he intends to pay for the advertisement, so that content delivery server can obtain information about an advertisement rate to be paid for each advertisement. The programming is regularly updated according to the thus obtained information about such advertisement rate, so that the advertisement rate for each advertisement can be dynamically reflected onto the programming. Accordingly, even if any change occurs in the ranking of advertisement rates, it is always possible to recognize an advertisement for which a high advertisement rate is expected to be paid, so as to associate the advertisement having a high advertisement rate with a content item which has a high access count.

(5) A content programming list, in which registered content URLs are arranged in descending order by access count, is organized and updated at regular intervals, and also, an advertisement programming list, in which registered advertisement URLs is arranged in descending order by advertisement rate, is organized and updated at regular intervals. The URLs listed in the content programming list and those in the advertisement programming list are extracted one by one, from the top of the lists alternately, thereby organizing and updating a made-for-delivery programming list at regular intervals. As a result, even with any changes in the ranking of access counts and in the ranking of advertisement rates, it is always possible to create and deliver a made-for-delivery programming list in which content items and advertisements are associated with one another in a one-to-one relationship in such a way that a content with a higher access count is associated with an advertisement with a higher advertisement rate.

Other objects and further features of the present invention will be apparent from the following detailed description when read in conjunction with the relevant accompanying drawings.

### BRIEF DESCRIPTION OF THE DRAWINGS

FIG. 1 is a block diagram showing a structure of content delivery system of one preferred embodiment of the present invention;

FIG. 2 is a view for illustrating a delivery process according to the present embodiment;

FIG. 3 is a flowchart illustrating a delivery process according to the present embodiment;

FIG. 4 is a view for illustrating a process of registering a content in the present embodiment;

FIG. 5 is an example of registered content data according to the present embodiment;

FIG. 6 is a view for illustrating a process of registering an advertisement;

FIG. 7 is an example of registered content data according to the present embodiment;

FIG. 8 is a process of counting accesses to each content in the present embodiment;

FIG. 9 is a data example of the access counts in the present embodiment;

FIG. 10 is a flowchart illustrating a process for organizing a content programming list according to the present embodiment;

FIG. 11 is an example of the content programming list of FIG. 10;

FIG. 12 is a flowchart illustrating a process for organizing an advertisement programming list according to the present embodiment;

FIG. 13 is an example of the advertisement programming list of FIG. 12;

FIG. 14 is a flowchart illustrating a process for organizing a made-for-delivery programming list according to the present embodiment;

FIG. 15 is an example of the made-for-delivery programming list of FIG. 14;

FIG. 16 is a view for illustrating a process for reproducing programming in a player of the present embodiment; and

FIG. 17 is a flowchart illustrating a process for reproducing programming in the player of the present embodiment.

### DESCRIPTION OF THE PREFERRED EMBODIMENT(S)

One preferred embodiment of the present invention will be described hereinbelow with reference to the relevant accompanying drawings.

[1] Description of one Embodiment:

[1-1] Construction of a Content Delivery System:

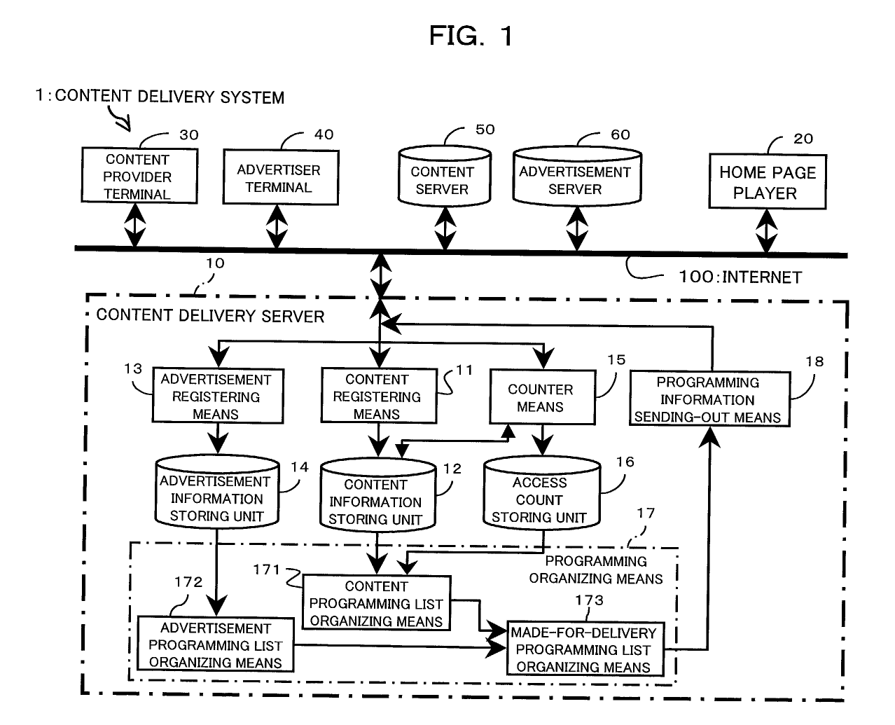

FIG. 1 is a block diagram showing a construction of a content delivery system of one preferred embodiment of the present invention. As shown in FIG. 1, content delivery system 1 includes content delivery server 10, home page player 20, content provider terminal 30, advertiser terminal (advertisement provider terminal) 40, content server 50, and advertisement server 60, all of which are communicably interconnected with one another via the Internet 100.

Content delivery server 10 is communicably connected with home page player 20 on the user (hereinafter also called a “viewer”) side so as to deliver programming (a URL-based programming list) Content delivery server 10 includes content registering means 11, content information storing unit 12, advertisement registering means 13, advertisement information storing unit 14, counter means 15, access count storing unit 16, programming organizing means 17, and programming information delivery means 18.

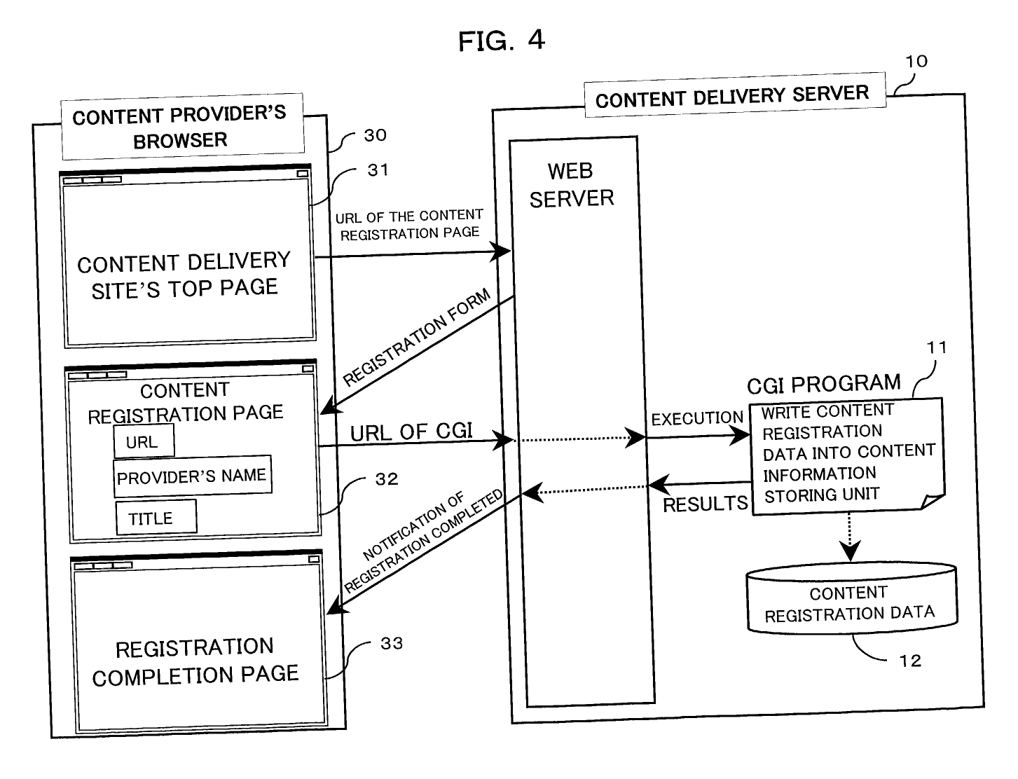

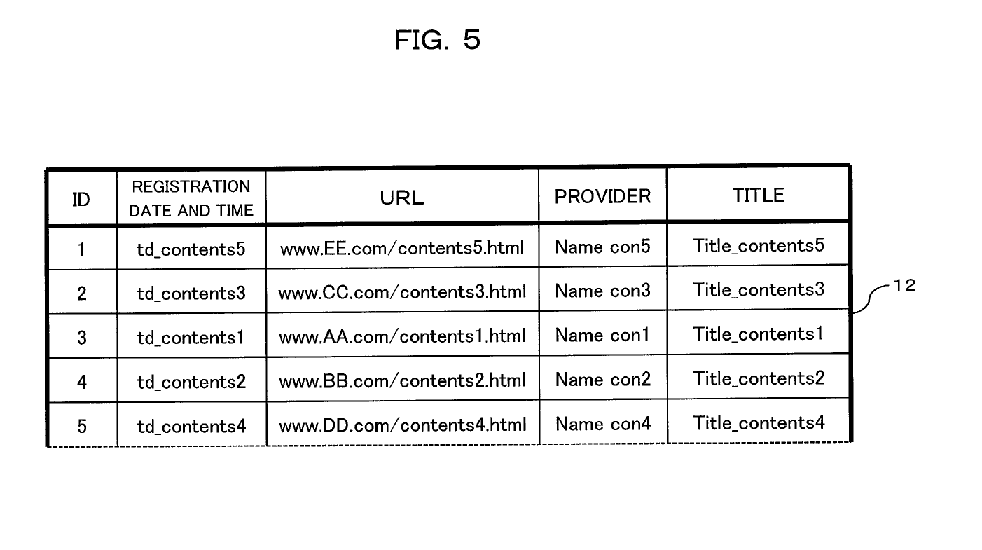

Content registering means 11 registers contents to be provided to users. A content provider accesses content registering means 11 from content provider terminal (browser) 30 to register a content's URL (address information) in content information storing unit 12. Such content URLs are accumulated and stored in content information storing unit 12 along with identification information (IDs), registration dates and times, provider names, and titles. A process for registering content and an example of registered data of such content will be described later with reference to FIG. 4 and FIG. 5.

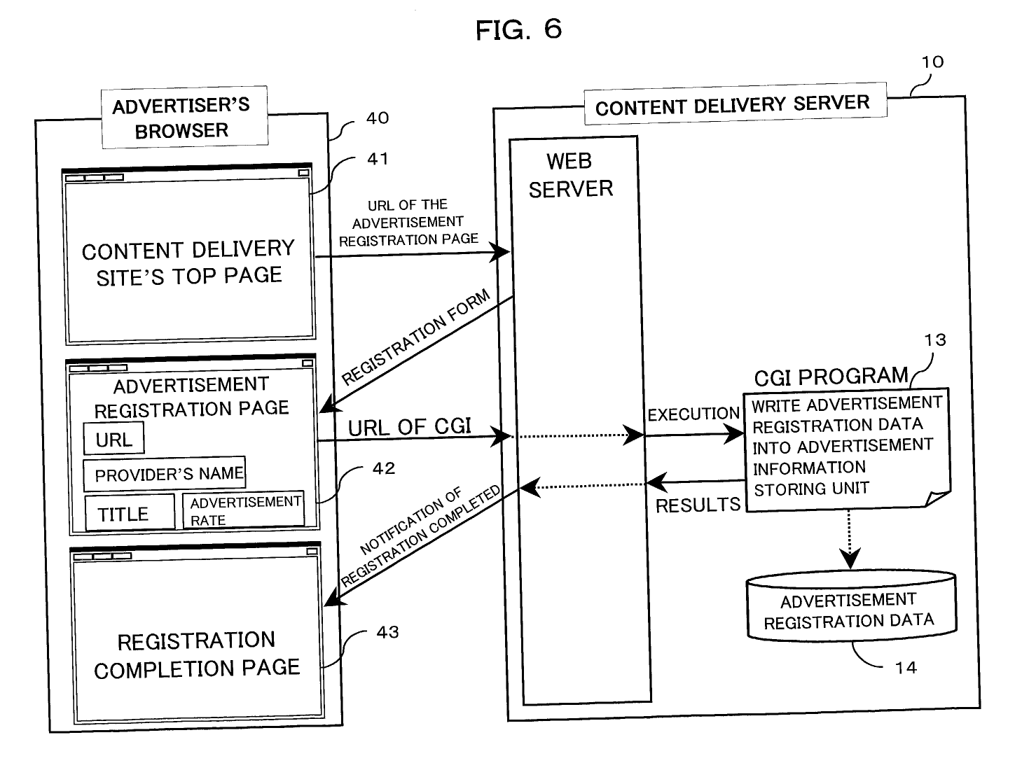

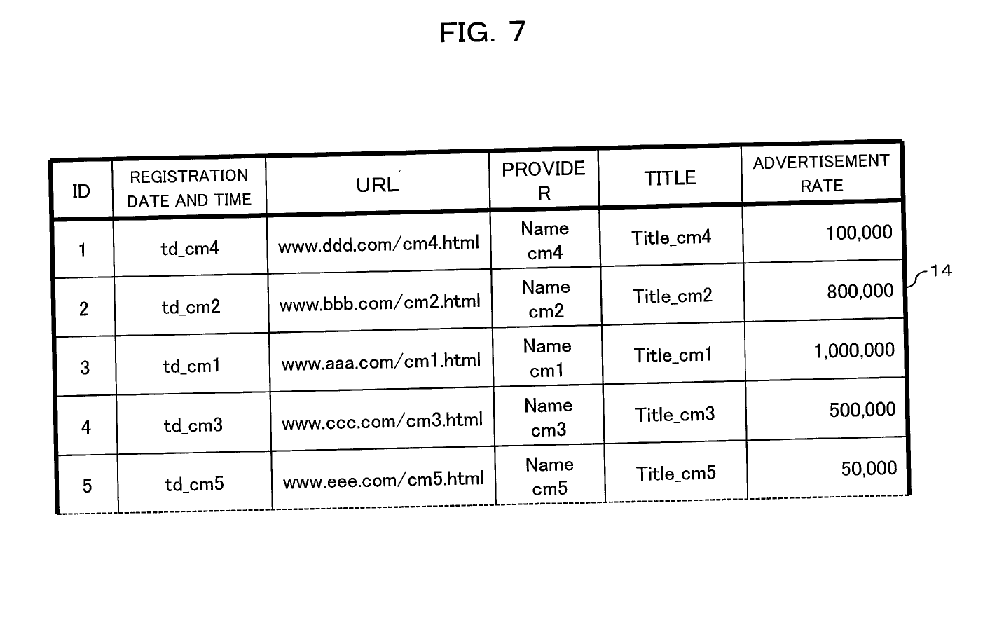

Advertisement registering means 13 registers advertisements to be provided to users. An advertiser accesses advertisement registering means 13 from advertiser terminal (advertisement provider) (browser) 40 to register an advertisement's URL (address information) in advertisement information storing unit 14. At that time, the advertiser declares how much he pays for the advertisement, and the advertisement rate is also registered in advertisement information storing unit 14 together with the advertisement URL. Such advertisement URLs are accumulated and stored in advertisement information storing unit 14 along with IDs, registration dates and times, advertiser names, and titles. A process for registering advertisements and an example of registered data of such advertisements will be described later with reference to FIG. 6 and FIG. 7.

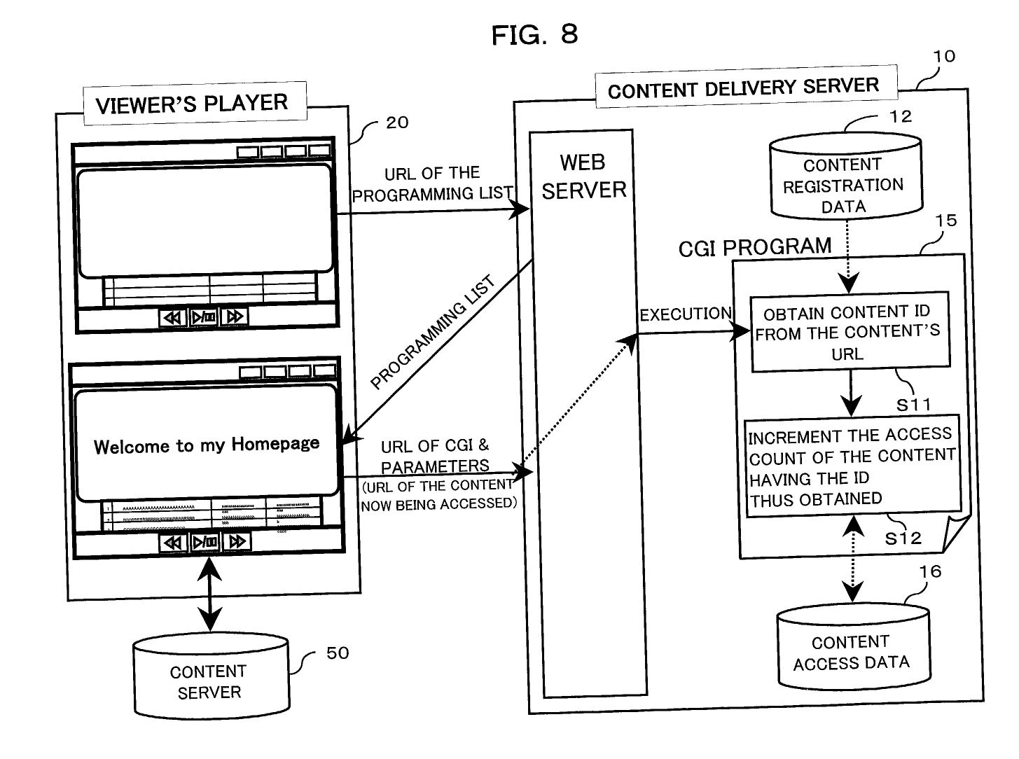

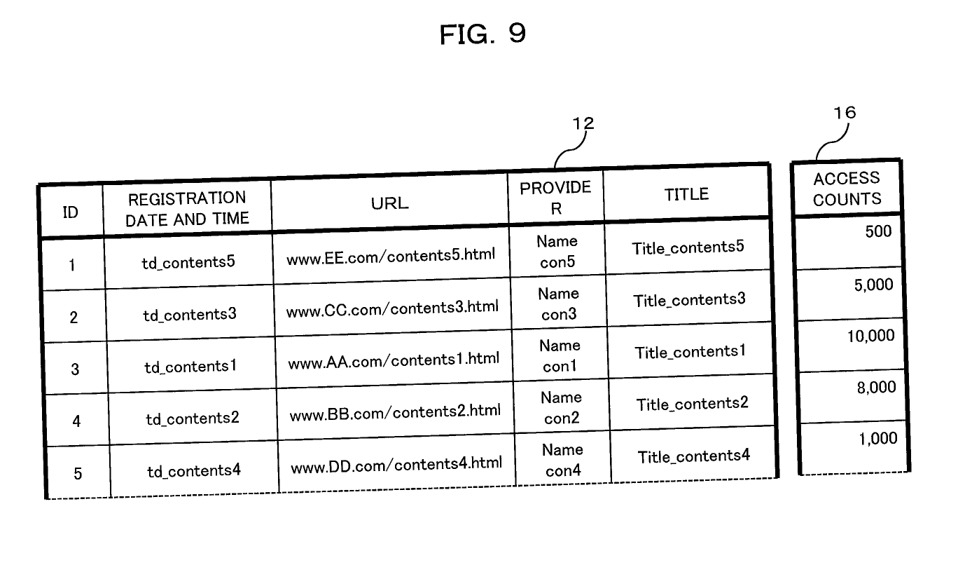

Counter means 15 counts accesses made to every item of content that has been registered by content registering means 11. Upon receipt of notification from home page player 20 that an access was made to a content file, counter means 15 increments the access count of the content, thereby executing a counting operation. The number of accesses, thus counted by counter means 15, to the content is accumulated and stored in access count storing unit 16 in association with the ID of the content. A process for counting accesses to an item of content and a data example of the access counts will be described later with reference to FIG. 8 and FIG. 9.

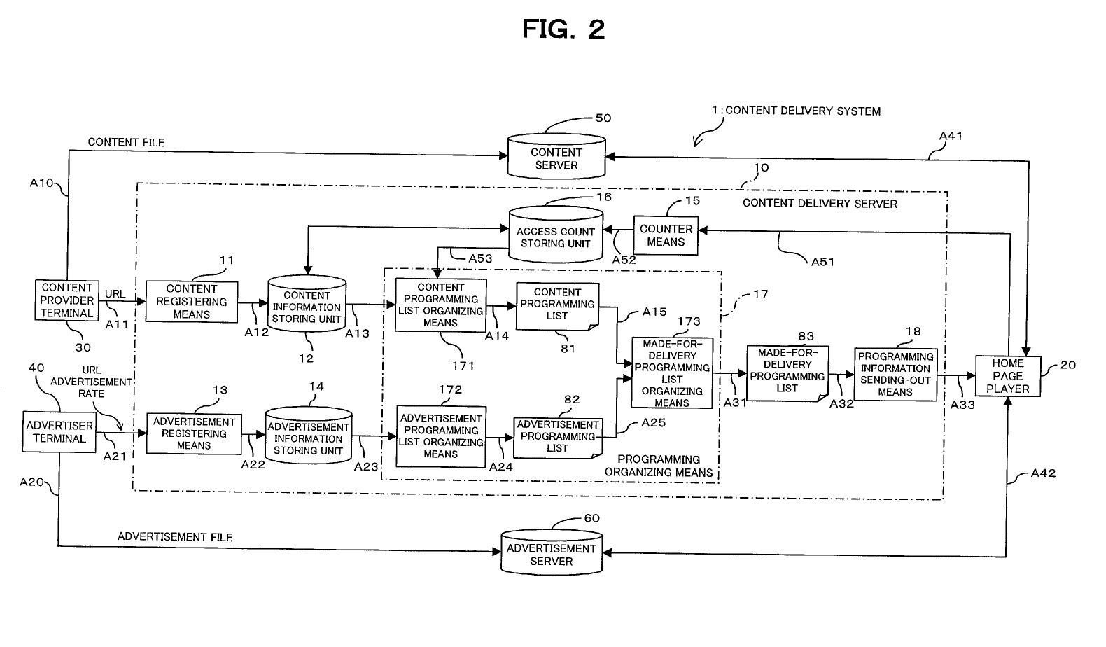

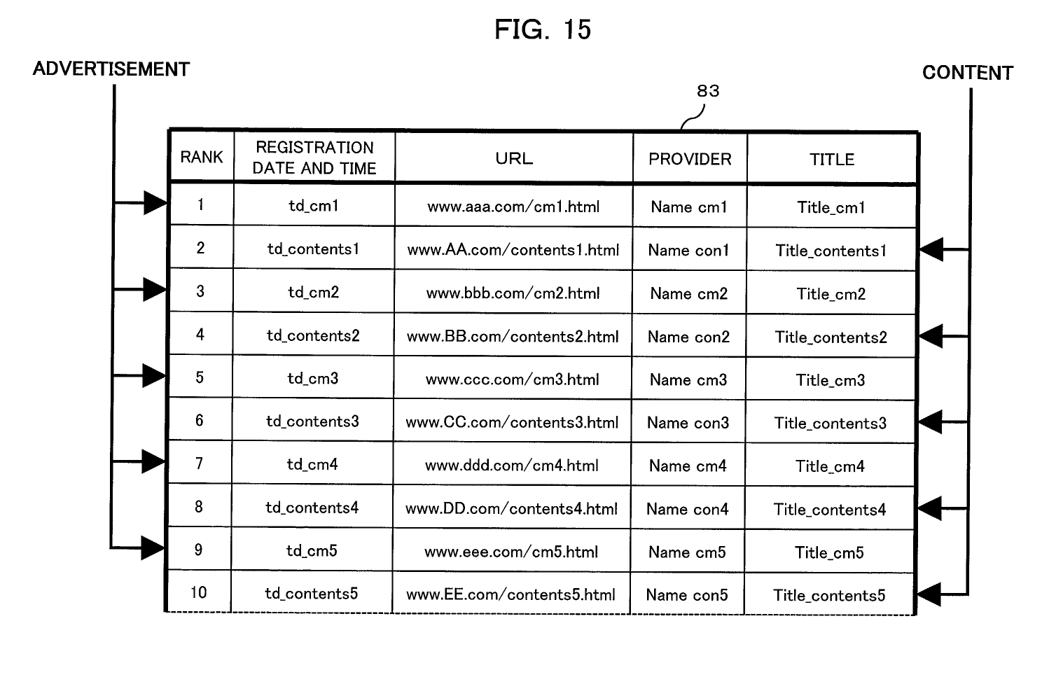

Programming organizing means 17 dynamically combines an item of content (a URL stored in content information storing unit 12), which has been registered by content registering means 11, and an advertisement (a URL stored in advertisement information storing unit 14), which has been registered by advertisement registering means 13, according to both the number (stored in access count storing unit 16) of accesses and the advertisement rate (stored in advertisement information storing unit 14), thereby organizing made-for-delivery programming list 83 (see FIG. 2 and FIG. 15), in which content URLs and advertisement URLs are recorded, as the programming. Made-for-delivery programming list 83 (programming) is updated by programming organizing means 17 at regular time intervals according to the number of accesses to each content item and the advertisement rate for each advertisement.

Programming organizing means 17 includes content programming organizing means 171, advertisement programming list organizing means 172, and made-for-delivery programming list organizing means 173.

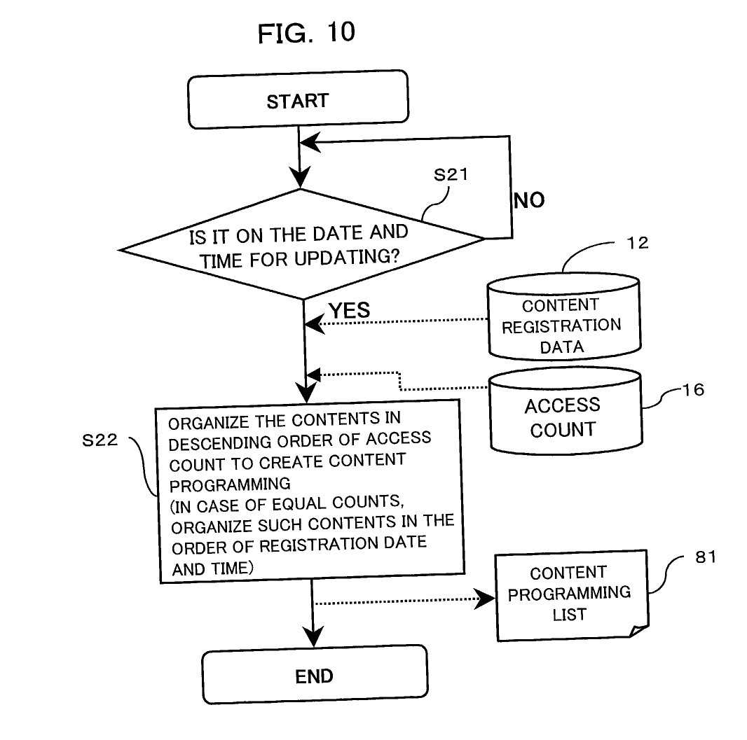

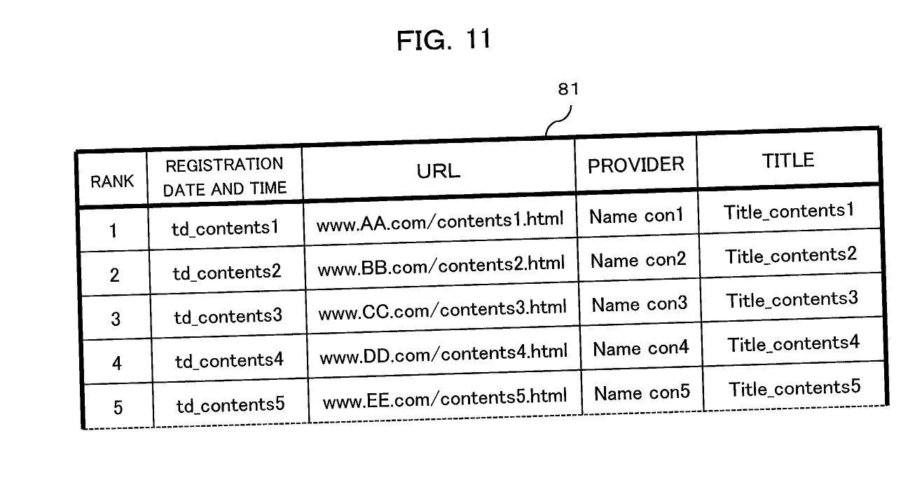

Content programming list organizing means 171 organizes and regularly updates content programming list 81 (see FIG. 2 and FIG. 11) that lists the content URLs, which has been registered by content registering means 11, in a descending order of the number of accesses to the content. A process of organizing such a content programming list and an example of the content programming list will be described later with reference to FIG. 10 and FIG. 11.

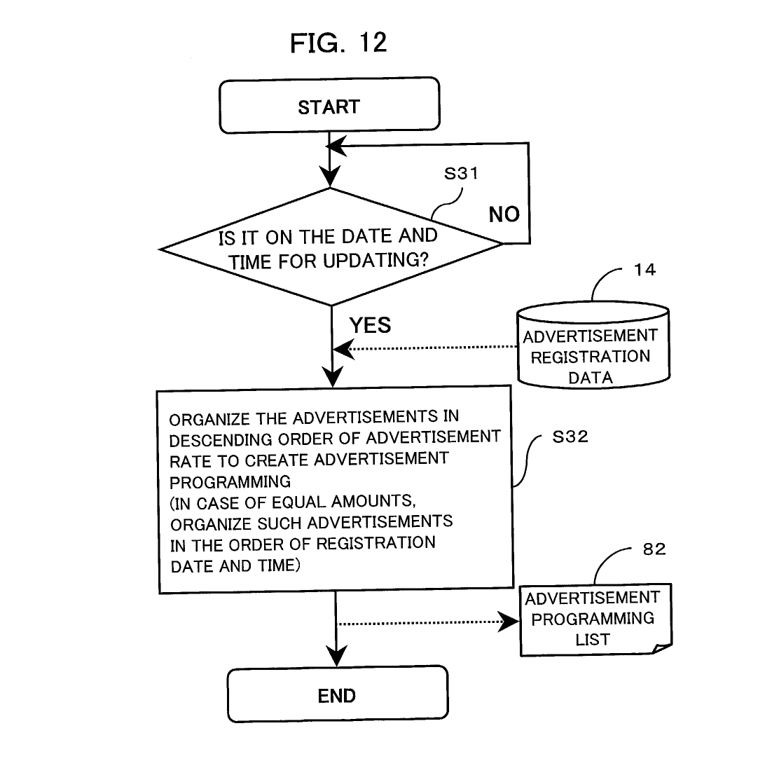

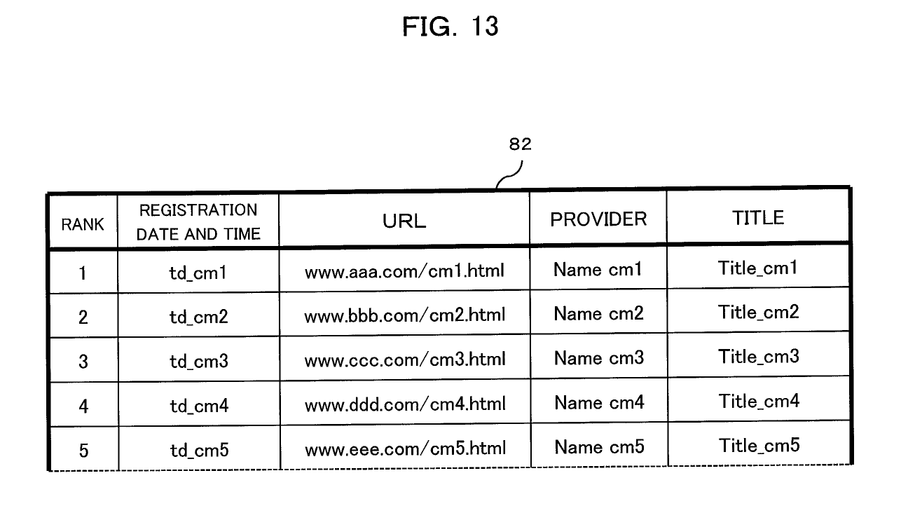

Advertisement programming list organizing means 172 organizes and regularly updates advertisement programming list 82 (see FIG. 2 and FIG. 13) that lists the advertisement URLs, which has been registered by advertisement registering means 13, in a descending order of the advertisement rate. A process of organizing such an advertisement programming list and an example of the content programming list will be described later with reference to FIG. 12 and FIG. 13.

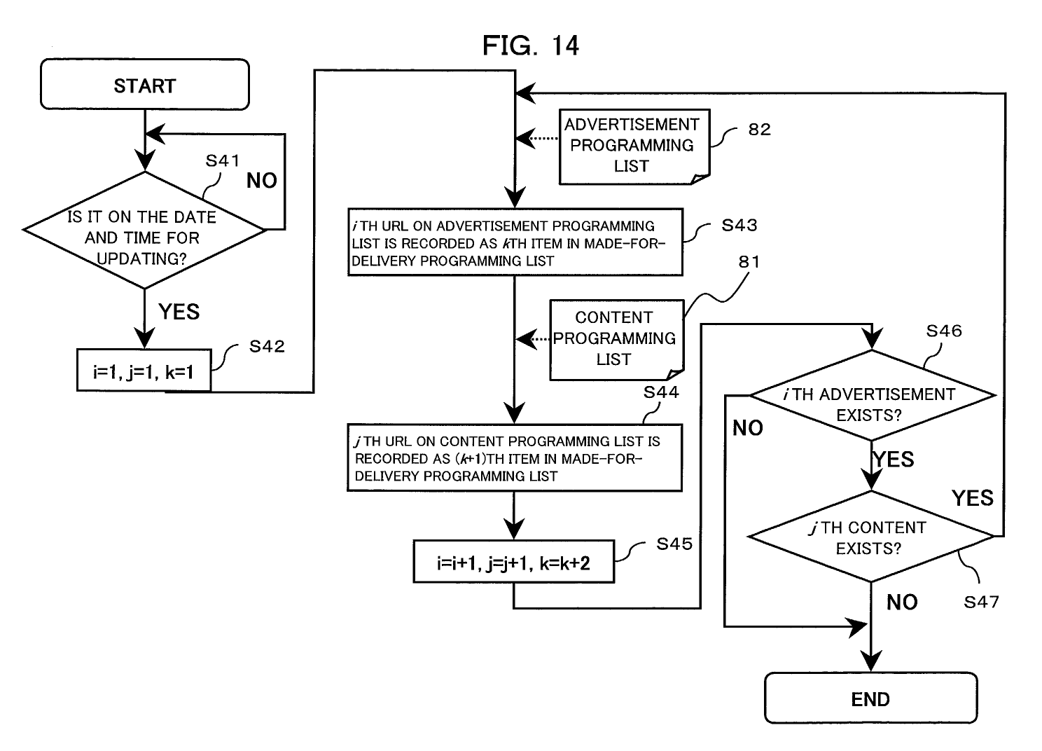

Made-for-delivery programming list organizing means 173 extracts the URLs listed in content programming list 81 and those in advertisement programming list 82 one by one, from the top of the lists alternately, thereby organizing made-for-delivery programming list 83 (see FIG. 2 and FIG. 15). A process of organizing such a made-for-delivery programming list and an example of the made-for-delivery programming list will be described later with reference to FIG. 14 and FIG. 15.

Programming organizing means 17 organizes a programming list composed of information units whose essential elements are URLs of content and those of advertisements on the Internet; that is, the programming of content and advertisements on the Internet is organized.

Programming information delivery means 18 sends out made-for-delivery programming list 83 to users as programming information about the programming, which has been organized by programming organizing means 17.

The above-described content registering means 11, advertisement registering means 13, counter means 15, programming organizing means 17 (content programming list organizing means 171, advertisement programming list organizing means 172, and made-for-delivery programming list organizing means 173), and programming information delivery means 18 are realized by dedicated software (content delivery management program).

The content delivery management program would be recorded in a computer-readable recording medium, such as a flexible disc and CD-ROM. In the present embodiment, such a content delivery management program is stored in a read only memory (ROM) (not shown), which constitutes content delivery server 10. The program is read out and executed by a CPU (computer) (not shown), which also constitutes content delivery server 10, to make the computer to function as registering means 11, advertisement registering means 13, counter means 15, programming organizing means 17, and programming information delivery means 18.

The content delivery management program can be recorded otherwise in a storage device (recording medium), such as a magnetic disc, optical disc, and magneto-optical disc, from which storage device the program may be provided to a computer via a communications network.

Content information storing unit 12, advertisement information storing unit 14, and access count storing unit 16 are realized by a storage unit, such as a random access memory (RAM) (not shown) or a hard disc, built in a computer constituting content delivery server 10 (or by a external storage medium).

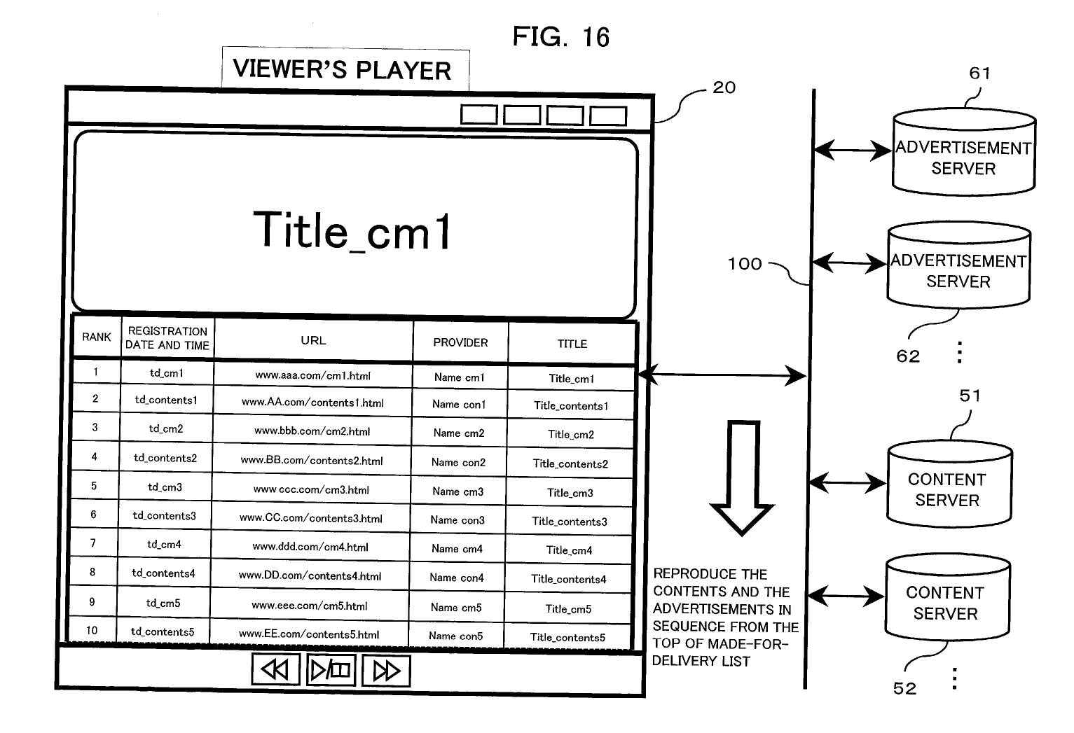

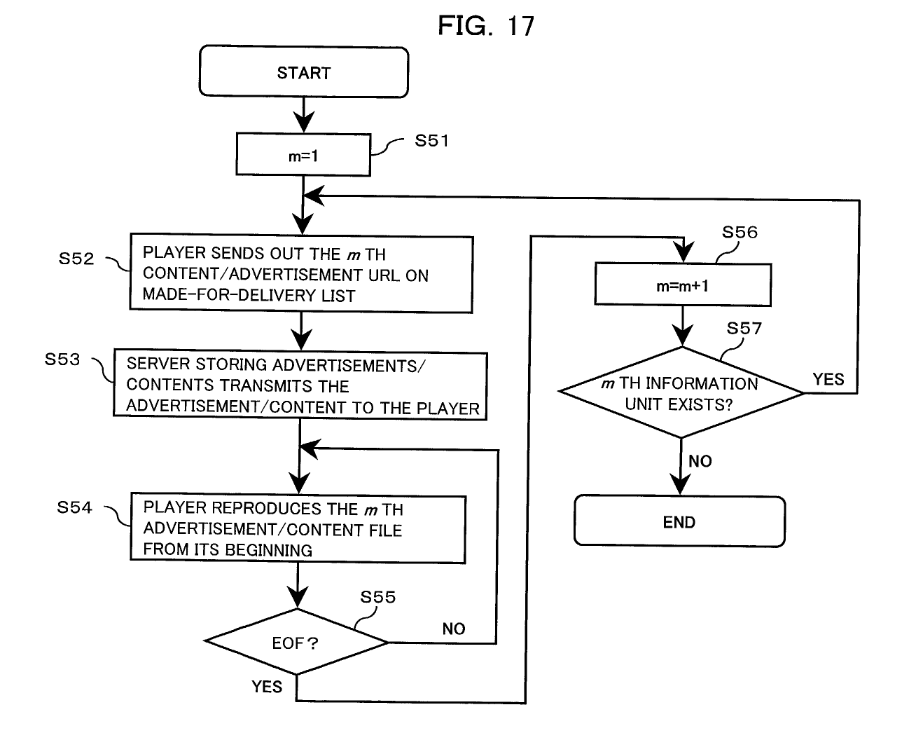

Home page player (player) 20, which is used by a user (viewer), reproduces programming according to made-for-delivery programming list 83 delivered from content delivery server 10 (programming information delivery means 18), so that the content and advertisements forming the programming are provided in sequence to the user. More precisely, upon receipt of made-for-delivery programming list 83, in which URLs are listed, home page player 20 refers in sequence to the URLs recorded in made-for-delivery programming list 83, and reproduces content and advertisement stored at the URLs, thereby reproducing the programming. As will be described later with reference to FIG. 8, home page player 20, when accessing a content file stored in content server 50, also carries out a function of providing counter means 15 of content delivery server 10 with notification of the access performed. A process of reproducing the programming on home page player 20 will be described later with reference made to FIG. 16 and FIG. 17.

Content server 50 (Web server/streaming server) accumulates and stores therein substantial content (files), while content delivery server 10 holds only the URLs of the content registered therein. Content server 50 stores content files that are accumulated therein by content providers from content provider terminals 30. As shown in FIG. 16 (items 51 and 52), more than one content server 50 may be provided.

Likewise, advertisement server (Web server/streaming server) 60 accumulates and stores therein substantial advertisements (files), while content delivery server 10 holds only the URLs of advertisements registered therein. Advertisement server 60 stores advertisement files that are accumulated therein by advertisers from advertiser terminal 40. As shown in FIG. 16 (items 61 and 62), more than one advertisement server 60 may be provided.

[1-2] Operation of Content Delivery System:

Referring to FIG. 2 through FIG. 17, a description will be made hereinbelow of an operation of content delivery system 1 with the foregoing structure of the present embodiment.

[1-2-1] Delivery Process:

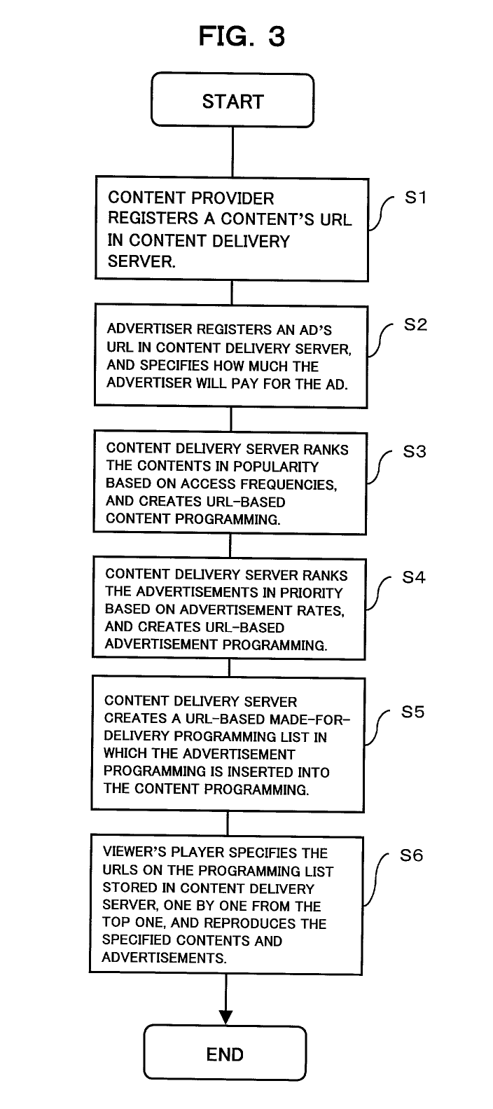

Referring now to FIG. 2 and FIG. 3, a delivery process carried out in content delivery system 1 will be described herein below. FIG. 2 and FIG. 3 are a diagram and a flowchart illustrating the process, respectively.

First of all, a content provider stores a content file to be provided to users in content server 50 from content provider terminal 30 via the Internet 100 (see arrow A10 of FIG. 2). As will be described with reference to FIG. 4 and FIG. 5, the content provider accesses content registering means 11 of content delivery server 10 to register the URL of the content file in content delivery server 10 (content information storing unit 12) (see arrow A11 and arrow A12 of FIG. 2, and step S1 of FIG. 3).

In the meantime, an advertiser stores an advertisement file, which is to be provided to users, in advertisement server 60 from advertiser terminal 40 via the Internet 100 (see arrow A20 of FIG. 2). As will be described later with reference to FIG. 6 and FIG. 7, the content provider accesses advertisement registering means 13 of content delivery server 10 to register the URL of the advertisement file in content delivery server 10 (advertisement information storing unit 14). At that time, the advertiser declares how much he intends to pay for the advertisement, and the advertisement rate is also registered in content delivery server 10 (advertisement information storing unit 14) together with the advertisement URL (see arrow A21 and arrow A22 of FIG. 2, and step S2 of FIG. 3).

As will be described later with reference to FIG. 10 and FIG. 11, in content delivery server 10 in which information about content and advertisements is registered, content programming list organizing means 171 refers at regular intervals to the URLs registered in content information storing unit 12 (see arrow A13 of FIG. 2), and also to the number of accesses to each content, which number is stored in access count storing unit 16 (see arrow A53 of FIG. 2). On the basis of the access frequencies, the items of content are ranked in popularity, and content programming list 81, in which content URLs are arranged in a descending order of the number of accesses to content, is organized (see arrow A14 of FIG. 2 and step S3 of FIG. 3).

As will be described later with reference to FIG. 12 and FIG. 13, advertisement programming list organizing means 172 refers to the registered URLs and advertisement rates stored in advertisement information storing unit 14 at regular intervals (see arrow A23 of FIG. 2). On the basis of advertisement rates, the advertisements are ranked in priority, and advertisement programming list 82, in which advertisement URLs are arranged in a descending order of the amount of advertisement rate, is organized (see arrow A24 of FIG. 2 and step S4 of FIG. 3).

As will be described later with reference to FIG. 14 and FIG. 15, made-for-delivery programming list organizing means 173 organizes made-for-delivery programming list 83 to be delivered to a user (home page player 20) based on content programming list 81 and advertisement programming list 82, both of which are thus created at regular intervals. More precisely, in the present embodiment, content URLs and advertisement URLs are extracted one by one from content programming list 81 and advertisement programming list 82, respectively, by turns, from the top of each list, so that made-for-delivery programming list 83 is regularly organized and updated (see arrows A15, A25, and A31 of FIG. 2, and step S5 of FIG. 3).

In this manner, made-for-delivery programming list 83, or a URL-based content programming list in which advertisement programs are inserted into content programs, is created, and thus created made-for-delivery programming list 83 is delivered from programming information delivery means 18 to a user (home page player 20) via the Internet 100 (see arrows A32 and A33 of FIG. 2).

Upon receipt of made-for-delivery programming list 83, as will be described later with reference to FIG. 16 and FIG. 17, home page player 20 reproduces the programming according to the received made-for-delivery programming list 83, so that the content and advertisements forming the programming are provided in sequence to the user. More precisely, home page player 20 successively refers to and specifies the URLs on made-for-delivery programming list 83 from the top of the list, and reads out content files and advertisement files corresponding to the URLs from content server 50 and advertisement server 60, respectively, by turns. In this manner, home page player 20 reproduces the content and advertisements successively, thereby reproducing the programming (see arrows A41 and A42 of FIG. 2, and step S6 of FIG. 3).

At that time, as will be described later with reference to FIG. 8 and FIG. 9, home page player 20, when accessing a content file stored in content server 50, provides counter means 15 of content delivery server 10 via the Internet 100 with notification of the access performed (arrow A51 of FIG. 2). Upon receipt of the notification from home page player 20 that an access was made to a content file, counter means 15 increments the access count of the corresponding content, which count is stored in access count storing unit 16 (arrows A51, A52, and A53 of FIG. 2).

[1-2-2] Content Registration Process:

Referring now to FIG. 4 and FIG. 5, a process for registering content in content delivery system 1 of the present embodiment will be described hereinbelow. FIG. 4 and FIG. 5 illustrate a process for registering content and an example of registered content data, respectively.

Using a form, provided by content delivery server 10, for registering content, a content provider registers a URL of content in content delivery server 10. For example, as shown in FIG. 4, the content provider selects the URL of content delivery site's top page 31, which is provided by content delivery server 10, on content provider terminal (browser) 30, so that content delivery site's top page 31 appears on the screen of content provider terminal 30. The content provider then accesses the URL of content registering page 32 to make content registration page 32, including the content registration form, shown on the screen of content provider terminal 30. On content registration page 32 thus shown, the content provider inputs the URL, the provider name, and the title of the content, and then applies for registration.

Upon receipt of the registration application from content provider terminal 30, content delivery server (Web server) 10 executes a common gateway interface (CGI) program which serves as content registering means 11. As shown in FIG. 5, with the function of content registering means 11, the URL, the provider name, and the title of the content are stored in content information storing unit 12 along with the date and time the registration was performed and the ID assigned to the content. Upon completion of registration of the content, content delivery server 10 (content registering means 11) notifies content provider terminal 30 of registration completed, and registration completion page 33 is shown on the screen of content provider terminal 30.

In this manner, with content delivery system 1 of the present embodiment, it is possible for content providers to utilize the URLs of content at registration of the content. As shown in FIG. 5, content information storing unit 12 of content delivery server 10 stores information units whose essential part is a URL, as registered content data.

[1-2-3] Advertisement Registration Process:

Referring now to FIG. 6 and FIG. 7, a process for registering advertisement in content delivery system 1 of the present embodiment will be described hereinbelow. FIG. 6 and FIG. 7 illustrate a process for registering an advertisement and an example of registered advertisement data, respectively.

An advertiser (or the one who intends to be an advertiser) uses an advertisement registration form, which is provided from content delivery server 10, to register a URL of advertisement in content delivery server 10. For example, as shown in FIG. 6, the advertiser selects the URL of content delivery site's top pate 41, which is provided by content delivery server 10, on advertiser terminal (browser) 40, so that content delivery site's top page 41 appears on the screen of advertiser terminal 40. The advertiser then accesses the URL of advertisement registration page 42 to show advertisement registration page 42, including the advertisement registration form, on the screen of advertiser terminal 40. On advertisement registration page 42 thus shown, the advertiser inputs the URL, the provider name, and the title of the advertisement, and also the amount he intends to pay for the advertisement (advertisement rate), and then applies for registration.

Upon receipt of the registration application from advertiser terminal 40, content delivery server (Web server) 10 executes a common gateway interface (CGI) program which servers as advertisement registering means 13. As shown in FIG. 7, with the function of advertisement registering means 13, the URL, the provider name, and the title of the advertisement are stored in advertisement information storing unit 14 along with the date and time the registration was performed and the ID assigned to the advertisement. Upon completion of registration of the advertisement, content delivery server 10 (advertisement registering means 13) notifies advertiser terminal 40 of the completion of registration, and registration completion page 43 is shown on the screen of advertiser terminal 40.

In this manner, with content delivery system 1 of the present embodiment, it is possible for advertisers to utilize the URLs of advertisements at registration of the advertisements, and it is also possible for the advertisers to declare how much they intend to pay for the advertisements. As shown in FIG. 7, advertisement information storing unit 14 of content delivery server 10 stores information units whose essential part is a URL and an advertisement rate, as registered advertisement data. In the example of FIG. 7, the item labeled with ID 1 has an amount of advertisement rate of 100,000; the one labeled with ID2, an amount of 800,000; the one labeled with ID 3, an amount of 1,000,000; the one labeled with ID 4, an amount of 500,000; and the one labeled with ID 5, an amount of 50,000.

[1-2-4] Access Counting Process:

Referring now to FIG. 8 and FIG. 9, a description will be made hereinbelow of a process for counting the number of accesses to each content item in content delivery system 1 of the present embodiment. FIG. 8 and FIG. 9 illustrate a process of access counting and an example of data of the number of accesses counted, respectively.

As shown in FIG. 8, a viewer activates home page player 20 on a user terminal, and specifies the URL of made-for-delivery programming list 83, which has been organized by content delivery server 10, to download the list 83. Upon receipt of made-for-delivery programming list 83, home page player 20 reproduces the programming (content and advertisements) according to the list 83. At that time, home page player 20, when accessing a content file stored in content server 50, provides counter means 15 of content delivery server 10 with notification that access was performed. The notification contains the URL of the content currently being accessed as a parameter, and is sent to the URL of a CGI of content delivery server 10.

Upon receipt of the notification from home page player 20, content delivery server (Web server) 10 executes the CGI program which serves as counter means 15. With the function of counter means 15, the ID of the content corresponding to the content URL, which has been notified as a parameter, is obtained (step S11), and the access counter of the content with the corresponding ID is incremented by one (step S12).

Access count storing unit 16, as shown in FIG. 9, accumulates and stores the number (access data) of accesses to each content item in association with the ID of the content. The access count of each content item is incremented/updated every time home page player 20 accesses the content. In the example of FIG. 9, the item labeled with ID 1 has an access count of 500; the one labeled with ID2, an access count of 5,000; the one labeled with ID 3, an access count of 10,000; the one labeled with ID 4, an access count of 8,000; and the one labeled with ID 5, an access count of 1,000.

At the moment an item of content is newly registered in step S1 of FIG. 3, the number of accesses to this content item stored in access count storing unit 16 takes an initial value of “0”. Accordingly, when a content that has already been significantly popular is registered, the access count counted by any other counter means may be registered in access count storing unit 16.

Further, counter means 15 is provided on content delivery server 10 according to the present embodiment, the function as counter means 15 may otherwise be provided to a server dedicated to counting the number of accesses. Or otherwise, content server 50 may have the function of counter means 15.

[1-2-5] Content Programming List Organizing Process:

Referring now to FIG. 10 and FIG. 11, a description will be made hereinbelow of a process for organizing a content programming list according to the present embodiment. FIG. 10 is a flowchart illustrating a process for organizing the content programming list; FIG. 11 shows an example of the content programming list.

As shown in FIG. 10, content programming list organizing means 171 checks the date and time for updating (step S21). If the predetermined date and time for updating arrives (YES route of step S21), content programming list organizing means 171 refers to registered URLs in content information storing unit 12 and to the number of accesses to each content stored in access count storing unit 16. Content programming list organizing means 171 arranges the content URLs in a descending order of access count, thereby creating content programming list 81 which complies with the ranking of the popularity of content (step S22).

In this manner, as shown in FIG. 11, content programming list 81 which is formed of information units whose essential part is a URL is created. In content programming list 81 of FIG. 11, the registered URLs of FIG. 5 are arranged in a descending order of the access count shown in FIG. 9.

If two or more content items rank the same in access count, the one that is registered earlier is given a higher priority. In addition, content programming list 81 is scheduled to be updated, for example, on a weekly basis.

[1-2-6] Advertisement Programming List Organizing Process:

Referring now to FIG. 12 and FIG. 13, a description will be made hereinbelow of a process for organizing an advertisement programming list according to the present embodiment. FIG. 12 is a flowchart illustrating a process for organizing the advertisement programming list; FIG. 13 shows an example of the advertisement programming list.

As shown in FIG. 12, advertisement programming list organizing means 172 checks the date and time for updating (step S31). If the predetermined date and time for updating arrives (YES route of step S31), advertisement programming list organizing means 172 refers to the registered URLs and advertisement rates in advertisement information storing unit 14. Advertisement programming list organizing means 172 arranges the advertisement URLs in descending order by advertisement rate, thereby creating advertisement programming list 82 which complies with the ranking of advertisement rate (step S32).

In this manner, as shown in FIG. 13, advertisement programming list 82 which is formed of information units whose essential part is a URL is created. In advertisement programming list 82 of FIG. 13, the registered URLs of FIG. 7 are rearranged in descending order by access count.

If two or more advertisements rank the same in advertisement rate, the one that is registered earlier is given a higher priority. In addition, advertisement programming list 82 is scheduled to be updated, for example, on a weekly basis.

[1-2-7] Made-for-delivery Programming List Organizing Process:

Referring now to FIG. 14 and FIG. 15, a description will be made hereinbelow of a process for organizing a made-for-delivery programming list according to the present embodiment. FIG. 14 is a flowchart illustrating a process for organizing the content programming list; FIG. 15 shows an example of the content programming list.

As shown in FIG. 14, made-for-delivery programming list organizing means 173 checks the date and time for updating (step S41). If the predetermined date and time for updating arrives (YES route of step S41), a value of “1” is set for each of the three parameters i, j, and k (step S42). Made-for-delivery programming list organizing means 173 refers to advertisement programming list 82 to extract the ith information unit (its essential part is an advertisement URL), and writes the extracted unit into made-for-delivery programming list 83 as its kth information unit (step S43).

Subsequently, made-for-delivery programming list organizing means 173 refers to content programming list 81 to extract the jth information unit (its essential part is an advertisement URL), and writes the extracted unit into made-for-delivery programming list 83 as its (k+1)th information unit (step S44).

After that, made-for-delivery programming list organizing means 173 replaces “i” with “i+1”; “j” with “j+1”; and “k” with “k+2” (step S45). Made-for-delivery programming list organizing means 173 evaluates whether or not the ith advertisement (information unit) is contained in advertisement programming list 82 (step S46), and also evaluates whether or not the jth content (information unit) exists in content programming list 81 (step S47). If both of the above exist (YES route of step S46 through YES route of step S47), made-for-delivery programming list organizing means 173 returns to step S43 and repeats the processing similar to the above. Otherwise, if neither the ith advertisement nor the jth content exists, or if only either one of them exists (NO route of step S46, or YES route of step S46 through NO route of step S47), made-for-delivery programming list organizing means 173 ends the process of organizing made-for-delivery programming list 83.

In this manner, made-for-delivery programming list organizing means 173 extracts the URLs listed in content programming list 81 and those in advertisement programming list 82 one by one, from the top of the lists by turns, thereby organizing made-for-delivery programming list 83, as of FIG. 15, which is formed of information units whose essential part is a URL (FIG. 15). Made-for-delivery programming list 83 of FIG. 15 is organized based upon advertisement programming list 82 of FIG. 13 and content programming list 81 of FIG. 11. In made-for-delivery programming list 83, advertisement information units and content information units are alternately arranged. The advertisement information units (advertisement URLs) are arranged in a descending order of advertisement rate, and the content information units (content URLs) are arranged in a descending order of access count.

Here, made-for-delivery programming list 83 is scheduled to be updated, for example, on a weekly basis. In that ease, made-for-delivery programming list 83 is organized and updated every week after the updating of content programming list 81 and advertisement programming list 82 is completed.

Further, in the present embodiment, if only either one of the ith advertisement and the jth content exists, the process for organizing made-for-delivery programming list 83 ends. At this time, if the ith advertisement exists with no existence of the jth content, the remaining advertisement information units may be written in made-for-delivery programming list 83 with no following content information units. Alternatively, the content information units having already been written may be read out once again in such a way that the remaining advertisement information units are arranged alternately with the thus read-out content information units. On the contrary, if the jth content exists with no existence of the ith advertisement, the remaining content information units may be written in made-for-delivery programming list 83. Alternatively, the advertisement information units having already been written may be read out once again in such a way that the remaining content information units are arranged alternately with the thus read-out advertisement information units.

In made-for-delivery programming list 83 of the present embodiment, every content information unit is associated with one single advertisement information unit. The present invention should by no means be limited to this, and two or more advertisement information units are associated with one content information unit.

[1-2-8] Programming Reproduction Process:

Referring now to FIG. 16 and FIG. 17, a description will be made hereinbelow of a process for reproducing programming on home page player 20. FIG. 16 illustrates a process for reproducing the programming; FIG. 17 is a flowchart illustrating an example of the advertisement programming list.

If a viewer (user) activates home page player 20 on his terminal, home page player 20 requests content delivery server 10 for made-for-delivery programming list 83, and receives made-for-delivery programming list 83 sent from content delivery server 10.

Upon receipt of made-for-delivery programming list 83 sent from content delivery server 10, home page player 20 reproduces the advertisements and the content items listed in made-for-delivery programming list 83, one by one from the top of made-for-delivery programming list 83, so that the advertisements and the content items are reproduced alternately (see FIG. 16). More precisely, home page player 20 successively refers to the URLs listed on made-for-delivery programming list 83, and reads out the files corresponding to the URLs from content server 51, 52, . . . and advertisement server 61, 62, . . . , via the Internet 100, to reproduce the content items and advertisements alternatively, so that the programming is reproduced.

Referring now to the flowchart (step S51 through step S57) of FIG. 17, a reproduction operation of home page player 20 will be described hereinbelow.

Upon receipt of made-for-delivery programming list 83, home page player 20 sets “1” for parameter m (step S51). Made-for-delivery programming list 83 then specifies the URL contained in the mth information unit in made-for-delivery programming list 83 and accesses the file (advertisement or content) at the specified URL (step S52).

Content server 50 (51, 52) or advertisement server 60 (61, 62) which stores the file with the specified URL, transmits the file (advertisement or content) to home page player 20 (step S53).

Upon receipt of the file sent from content server 50 or advertisement server 60, home page player 20 reproduces the file (advertisement or content), which corresponds to the mth information unit in made-for-delivery programming list 83, from the top of the file (step S54).

When reaching the end of the file (EOF) (YES route of step S55), home page player 20 replaces “m” with “m+1” (step S56), and then evaluates whether or not made-for-delivery programming list 83 has the mth information unit (step S57). If the mth information unit does not exist (NO route of step S57), the reproduction process ends. Or otherwise, if the mth information exists (YES route of step S57), home page player 20 returns to step S52, and repeats the processing similar to the above.

In accordance with made-for-delivery programming list 83, home page player 20 first sends out on the Internet 100 the advertisement URL on the top of made-for-delivery programming list 83. In response to the advertisement request, advertisement server 60 (61, 62) transmits the requested advertisement file to home page player 20. Upon receipt of the file, home page player 20 reproduces the advertisement. The advertisement page is reproduced from its top. Text part is voice-synthesized, and a helper (dedicated player) is activated to reproduce the part linked with a music file or a movie file. After completion of reproduction of the advertisement page, home page player 20 sends out on the Internet 100 another content URL to be reproduced according to made-for-delivery programming list 83. Upon receipt of the content request, content server 50 (51, 52) transmits the corresponding content file. Likewise, home page player 20 repeats the reproduction of advertisements and content items listed on made-for-delivery programming list 83 until the last item on the list is reproduced.

[1-3] Effects and Profits of the Embodiment:

As described above, in content delivery system 1 of one preferred embodiment of the present invention, programming organizing means 17 dynamically combines content items, which have been registered by content registering means 11, and advertisements, which have been registered by advertisement registering means 13, according to the number of accesses to each content item and the advertisement rate, thereby organizing programming. Programming information delivery means 18 sends out programming information of the thus organized programming to a user, and home page player 20 on the user side reproduces the received programming. As a result, it is possible to provide an automatic way for organizing programming in which content with higher popularity (audience rating) is dynamically combined with an advertisement with a greater advertisement rate.

Further, it is possible for a content provider and advertiser to make their content and advertisement delivered to home page player 20 of users as such programming, merely by registering the URLs of the content and advertisement to be delivered through content registering means 11 and advertisement registering means 13, respectively. At that time, made-for-delivery programming list 83 is organized based on the registered URLs, and home page player 20 reproduces the content and advertisements corresponding to the URLs listed in made-for-delivery programming list 83.

As a result, once content providers and advertisers accumulate and store the contents and advertisements they would like to provide to users in content server 50 (51, 52) and advertisement server 60 (61, 62), respectively, on the Internet, it is possible for them to register with significant ease the URLs of such content and advertisements in content delivery server 10 (content delivery site). Further, programming organizing means 17 is capable of organizing programming with significant ease by utilizing the URLs of the contents and advertisements.

Further, even if such contents and advertisements are stored in a number of servers on the Internet 100, content delivery system 1 (content delivery server 10) plays a leading role in organizing the contents and advertisements into programming as in the case of telecasting. That is, it is possible for Internet viewers (users) to enjoy such programming that is formed of varying content items, including those provided by private individuals and also those provided by business companies, stored in distributed servers on the Internet 100. The content items forming the programming are reproduced in a non-selective manner like a datastream of telecasting.

Counter means 15 counts the number of accesses to each of the registered contents. The programming is updated at regular intervals according to the access counts, so that the access counts, which indicate the popularity of the content, are dynamically reflected on the programming. Accordingly, even with changes in the number of accesses to each content item, it is always possible to recognize an content item which is frequently accessed, or high-rated content, and it is possible to associate such content with an advertisement for which a high advertisement rate is expected to be paid. At that time, home page player 20 notifies counter means 15 that access was made to a content file, and upon receipt of the access notification, counter means 15 increments the access count of the corresponding content, so that the number of accesses to each content can be counted with ease and certainty.

When registering an advertisement URL, an advertiser declares how much he intends to pay for the advertisement, so that content delivery server 10 can obtain, with certainty, information about an advertisement rate to be paid for each advertisement. The programming is regularly updated according to the thus obtained information about such advertisement rate, so that the advertisement rate for each advertisement can be dynamically reflected onto the programming. Accordingly, even if any change occurs in the ranking of advertisement rates, it is always possible to recognize an advertisement for which a higher advertisement rate is expected to be paid, so as to associate the advertisement with a content item which has a higher access count.

Further, content programming list 81, in which registered content URLs are arranged in descending order by access count, is organized and updated at regular intervals, and also, advertisement programming list 82, in which registered advertisement URLs is arranged in descending order by advertisement rate, is organized and updated at regular intervals. The URLs listed in content programming list 81 and those in advertisement programming list 82 are extracted one by one, from the top of the lists alternately, thereby organizing and updating made-for-delivery programming list 83 at regular intervals. As a result, even with any changes in the ranking of access counts and in the ranking of advertisement rates, it is always possible to create and deliver a made-for-delivery programming list 83 in which content items and advertisements are associated with one another in a one-to-one relationship in such a way that a content with a higher access count is associated with an advertisement with a higher advertisement rate.

[2] Other Modifications:

The present invention should by no means be limited to the above-illustrated embodiment, and various changes or modifications may be suggested without departing from the gist of the invention.

For example, in the above-described embodiment, the updating of the programming lists is carried out once a week. The present invention should by no means be limited to this, and such updating may be carried out at shorter or longer time intervals. Additionally, in the above-described embodiment, content delivery server 10 includes content registering means 11, content information storing unit 12, advertisement registering means 13, advertisement information storing unit 14, counter means 15, access count storing unit 16, programming organizing means 17, and programming information delivery means 18. The present invention should by no means be limited to this, and these elements can be distributed among two or more servers.

What is claimed is:

1. A content delivery system for delivering programming across a communications network to a user, said system comprising:
content registering means for registering each content to be delivered to said user;
advertisement registering means for registering each advertisement to be delivered to said user;
means for organizing said programming, said programming being formed of such contents, which have been registered by said content registering means, and such advertisements, which have been registered by said advertisement registering means, in combination created dynamically based upon both the number of accesses to said content and the amount of payment for said advertisement;
means for sending out programming information about said programming, which has been organized by said programming organizing means, to said user; and
a player for reproducing said programming according to said programming information, so that said contents and said advertisements both forming said programming are offered to said user.

2. A system as set forth in claim 1, comprising a content delivery server for delivering said programming to said player communicably connected with said control delivery server across a communications network, said server serving as said content registering means, said advertisement registering means, said programming organizing means, and said programming information delivery means.

3. A system as set forth in claim 2, further comprising:
a content server, communicably connected with said player across a communications network, for storing a file of said each content to be registered by said content registering means; and
an advertisement server, communicably connected with said player across a communications network, for storing a file of said each advertisement to be registered by said advertisement registering means,
said content registering means registering said each content in the form of first address information (hereinafter called “content address information”) about an address of said content on said content server,
said advertisement registering means registering said each advertisement in the form of second address information (hereinafter called “advertisement address information”) about an address of said advertisement on said advertisement server,
said programming organizing means organizing said programming in the form of a made-for-delivery programming list in which both said content address information and said advertisement address information are listed,
said programming information delivery means sending out said made-for-delivery programming list as said programming information, and
said player, responsive to receipt of said made-for-delivery programming list, referring to each item of said content address information and each item of said advertisement address information successively, which items are listed in said made-for-delivery programming list, and reading out files which correspond to said each item of content address information and said each item of said advertisement address information from said content server and said advertisement server, respectively, so as to reproduce said programming.

4. A system as set forth in claim 3, wherein:
said communications network, via which said player is connected with the individual servers, is the Internet; and
the individual address information is a uniform resource locator (URL).

5. A system as set forth in claim 3, further comprising a content provider terminal, communicably connected with said content delivery server across a communications network, for use by a content provider to access said content delivery server for registering such content address information through said content registering means.

6. A system as set forth in claim 3, further comprising counter means for counting the number of accesses made to said each content registered by said content registering means,
said programming organizing means updating said programming at regular time intervals in accordance with said number of accesses counted by said counter means.

7. A system as set forth in claim 6, further comprising:
a first storing unit for accumulating and storing said content address information, which is registered therein by said content registering means; and
a second storing unit for accumulating and storing said number of accesses made to said each content, which number has been counted by said counter means, in association with said each content.

8. A system as set forth in claim 6, wherein said counter means is provided on said content delivery server.

9. A system as set forth in claim 6, wherein:
said player, upon access to a file of said content stored in said content server, provides said counter means with notification of the access performed; and
said counter means, upon receipt of such access notification from said player, advances the count of accesses to said content.

10. A system as set forth in claim 3, further comprising an advertisement provider terminal, communicably connected with said content delivery server across a communications network, for use by an advertisement provider to access said content delivery server for registering such advertisement address information through said advertisement registering means and for specifying an amount of payment to be paid for the advertisement.

11. A system as set forth in claim 3, further comprising a storing unit for accumulating and storing both said advertisement address information, which is registered therein by said advertisement registering means, and said amount of payment for the advertisement in association with one another.

12. A system as set forth in claim 3, wherein said programming organizing means includes:
means for creating and regularly updating a content programming list in which a plurality of items of content address information, which have been registered by said content registering means, are listed in a descending order of said number of accesses to the individual contents;
means for creating and regularly updating an advertisement programming list in which a plurality of items of advertisement address information, which have been registered by said advertisement registering means, are listed in a descending order of said amount of payment for the individual advertisements; and
means for creating and regularly updating said made-for-delivery programming list, by extracting each one of said items of content address information and each one of said items of advertisement address information by turns, from the one positioned highest in the individual lists, and by associating the extracted item of content address information with the extracted item of advertisement address information.

13. A content delivery server, communicably connected with a player on a user side across a communications network, for delivering programming to said player, said server comprising:
content registering means for registering each content to be delivered to said user;
advertisement registering means for registering each advertisement to be delivered to said user;
means for organizing said programming, said programming being formed of such contents, which have been registered by said content registering means, and such advertisements, which have been registered by said advertisement registering means, in combination created dynamically based upon both the number of accesses to said content and the amount of payment for said advertisement; and
means for sending out programming information about said programming, which has been organized by said programming organizing means, to said user.

14. A content delivery server as set forth in claim 13, wherein:
said content registering means registers said each content in the form of first address information (hereinafter called “content address information”) about an address of said content on said content server;
said advertisement registering means registers said each advertisement in the form of second address information (hereinafter called “advertisement address information”) about an address of said advertisement on said advertisement server;
said programming organizing means organizing said programming in the form of a made-for-delivery programming list in which both said content address information and said advertisement address information are listed; and
said programming information delivery means sending out said made-for-delivery programming list as said programming information.

15. A content delivery server as set forth in claim 14, wherein the individual address information is a uniform resource locator (URL).

16. A content delivery server as set forth in claim 14, further comprising counter means for counting the number of accesses made to said each content registered by said content registering means,
said programming organizing means updating said programming at regular time intervals in accordance with said number of accesses counted by said counter means.

17. A content delivery server as set forth in claim 16, further comprising:
a first storing unit for accumulating and storing said content address information, which is registered therein by said content registering means; and
a second storing unit for accumulating and storing said number of accesses made to said each content, which number has been counted by said counter means, in association with said each content.

18. A content delivery server as set forth in claim 16, wherein said counter means, responsive to notification of accessing to a content file received from said player, which reproduces said programming according to said made-for-delivery programming list delivered from said programming information delivery means, advances the count of accesses to the corresponding content.

19. A content delivery server as set forth in claim 14, further comprising a storing unit for accumulating and storing both said advertisement address information, which is registered therein by said advertisement registering means, and said amount of payment for the advertisement in association with one another.

20. A content delivery server as set forth in claim 14, said programming organizing means includes:
means for creating and regularly updating a content programming list in which a plurality of items of content address information, which have been registered by said content registering means, are listed in a descending order of said number of accesses to the individual contents;
means for creating and regularly updating an advertisement programming list in which a plurality of items of advertisement address information, which have been registered by said advertisement registering means, are listed in a descending order of said amount of payment for the individual advertisements; and
means for creating and regularly updating said made-for-delivery programming list, by extracting each one of said items of content address information and each one of said items of advertisement address information by turns, from the one positioned highest in the individual lists, and by associating the extracted item of content address information with the extracted item of advertisement address information.

21. A recording medium in which a content delivery management program for a computer to manage the delivering of programming, sent out on a communications network and directed to a player on a user side, is recorded, wherein said program instructs the computer to function as the following:
content registering means for registering each content to be delivered to said user;
advertisement registering means for registering each advertisement to be delivered to said user;
means for organizing said programming, said programming being formed of such contents, which have been registered by said content registering means, and said advertisements, which have been registered by said advertisement registering means, in combination created dynamically based upon both the number of accesses to said content and the amount of payment for said advertisement; and
means for sending out programming information about said programming, which has been organized by said programming organizing means, to said user.

22. A recording medium as set forth in claim 21, wherein said computer program instructs the computer to function in such a way that:
said content registering means registers said each content in the form of first address information (hereinafter called “content address information”) about an address of said content on said content server;
said advertisement registering means registers said each advertisement in the form of second address information (hereinafter called “advertisement address information”) about an address of said advertisement on said advertisement server;
said programming organizing means organizes said programming in the form of a made-for-delivery programming list in which both said content address information and said advertisement address information are listed; and
said programming information delivery means sends out said made-for-delivery programming list as said programming information.

23. A recording medium as set forth in claim 22, wherein the individual address information is a uniform resource locator (URL).

24. A recording medium as set forth in claim 22, wherein:
said computer program further instructs the computer to function as counter means for counting the number of accesses made to each content registered by said content registering means; and
said computer program further instructs the computer to function in such a way that said programming organizing means updates said programming at regular time intervals in accordance with said number of accesses counted by said counter means.

25. A recording medium as set forth in claim 24, wherein said computer program further instructs the computer to function in such a way that said counter means, responsive to notification of accessing to a content file received from said player, which reproduces said programming according to said made-for-delivery programming list delivered from said programming information delivery means, advances the count of accesses to said content.

26. A recording medium as set forth in claim 22, wherein said computer program instructs the computer to function as said programming organizing means which includes:
means for creating and regularly updating a content programming list in which a plurality of items of content address information, which have been registered by said content registering means, are listed in a descending order of said number of accesses made to the individual contents;
means for creating and regularly updating an advertisement programming list in which a plurality of items of advertisement address information, which have been registered by said advertisement registering means, are listed in a descending order of said amount of payment for the individual advertisements; and
means for creating and regularly updating said made-for-delivery programming list, by extracting each one of said items of content address information and each one of said items of advertisement address information by turns, from the one positioned highest in the individual lists, and by associating the extracted item of content address information with the extracted item of advertisement address information.
